(19) United States
(12) Patent Application Publication
(10) Pub. No.: US 2005/0186477 A1
(43) Pub. Date: Aug. 25, 2005

(54) Current collector for a lithium secondary battery and a lithium secondary battery comprising the same

(76) Inventor: Jae-Yul Ryu, Suwon-si (KR)

Correspondence Address: CHRISTIE, PARKER & HALE, LLP, PO BOX 7068, PASADENA, CA, 91109-7068, US

(21) Appl. No.: 11/060,984

(22) Filed: Feb. 18, 2005

(30) Foreign Application Priority Data
Feb. 25, 2004 (KR) 10-2004-0012615

(51) Int. Cl. H01M 4/66

(52) U.S. Cl. 429/245; 429/231.95

(57) ABSTRACT

Disclosed is a current collector for a positive electrode used in a lithium secondary battery including an aluminum alloy comprising from 98 to 99.5 wt % aluminum, and having a tensile strength ranging from 115 MPa to 265 MPa, and preferably from 115 MPa to 160 MPa.

### CROSS REFERENCE TO RELATED APPLICATION

This application claims priority to and is based on Korean Patent application No. 10-2004-0012615 filed in the Korean Intellectual Property Office on Feb. 25, 2004, the entire disclosure of which is incorporated hereinto by reference.

### FIELD OF THE INVENTION

The present invention relates to a current collector for a lithium secondary battery and a lithium secondary battery comprising the same, and more specifically, to a current collector for a lithium secondary battery which helps to prevent the electrode from bending when pressed, and a lithium secondary battery comprising the same.

### BACKGROUND OF THE INVENTION

The use of portable electronic instruments is increasing as electronic equipment gets smaller and lighter due to developments in the high-tech electronics industries. Studies on secondary batteries are actively being pursued in accordance with the increased need for batteries having high energy density for use in such portable electronic instruments.

Lithium secondary batteries may be classified as prismatic type, cylindrical type, or pouch type depending on the shape. Such batteries generally include an electrode assembly comprising a positive electrode and a negative electrode with a separator between them.

The conventional electrode includes a current collector and active material layers coated on both surfaces of the current collector except at an edge portion which is referred to here as an “uncoated part”.

An electrode as stated above is fabricated by a compressing process after an active material composition has been coated on a current collector and dried. The active material composition is made by mixing active material, a binder, and optionally, a conductive agent with a solvent. However, differences in elongation rate between the uncoated part and the part coated with the active material layer during compressing may result in the electrode being bent.

One method for preventing such a problem is to reduce the active material density of the electrode, but such a method tends to result in decreased energy density. Another method involves the heat treatment of an electrode as described in Japanese patent application laid-open No. 2001-76711. However, such a heat treatment method also has problems in that it adds to the production costs of fabricating a battery due to the added heat treatment step.

### SUMMARY OF THE INVENTION

In one embodiment of the present invention, a positive electrode current collector for a lithium secondary battery is provided which is strong enough to resist being bent during compressing, yet such benefit is provided without reducing the energy density.

In another embodiment of the present invention, a lithium secondary battery is provided including the above current collector.

In yet another embodiment of the present invention, a current collector is provided for a positive electrode used in a lithium secondary battery that includes an aluminum alloy and that has a tensile strength of 115 MPa to 265 MPa. In such an embodiment, the content of aluminum in the current collector is between about 98 and 99.5 weight percent (wt %) of aluminum.

In still another embodiment of the present invention, a lithium secondary battery is provided including a positive electrode including the positive electrode current collector and a positive active material layer formed on the current collector; a negative electrode including a negative active material; and an electrolyte.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a cross-sectional view schematically illustrating a lithium secondary battery of the present invention; and

FIG. 2 is a partial perspective view illustrating an electrode shown in FIG. 1 after it has been compressed.

### DETAILED DESCRIPTION

The present invention relates to a current collector used in a positive electrode for a lithium secondary battery, which is sufficiently strong to prevent the electrode from being bent due to the differences in elongation rates between an uncoated part and a coated part of the current collector, and which does not substantially affect the physical properties of the battery in an adverse way.

The current collector of one embodiment of the present invention includes an aluminum alloy, and has a tensile strength from 115 MPa to 265 MPa, and preferably from 115 MPa to 160 MPa. The aluminum alloy is generally from 98 to 99.5 weight percent (wt %) of aluminum.

The current collector has physical properties as described above, even though the purity is slightly below that of pure aluminum. The electrode is resistant to being bent by the differences in elongation rates between the uncoated part 3a of the current collector and the coated part which has been coated with an active material layer 5 of the electrode due to a high degree of strength and a low elongation rate. In addition, an additional heat treatment process does not need to be performed, and the density of the pole plate is not reduced. If the tensile strength of the positive electrode current collector stated above is less than 115 MPa or the degree of purity thereof is lower than 98%, the physical properties of the resulting battery may deteriorate. If the tensile strength is more than 265 MPa or the degree of purity is higher than 99.5%, the strength may decrease along with the current collector's resistance to bending.

Since the positive electrode current collector of the present invention is not pure aluminum and is formed of an aluminum alloy, it may include impurities such as Si, Cu, Mn, or Mg.

Exemplary aluminum alloys satisfying the physical properties stated above include Al1050H16, Al1050H18, Al1060H18, Al1350H16, Al1350H19, Al1100H14, Al1100H16, Al1100H18, or Al31050. In the present specification, the designation “Al1xxxHyy” refers to a system for naming aluminum alloys, wherein “Al1xxx” refers to a wrought aluminum alloy with an aluminum content of more than 99.00%. According to this designation, the first digit after the number 1 corresponds to the type of impurities and the second and third digits after the number 1 denote the decimal portion of the aluminum content. For example, “Al1050” denotes a 99.50% aluminum alloy while “Al1060” denotes a 99.60% aluminum alloy. In addition, “H” denotes that the material has been strain hardened, the first digit of “yy” indicates that the material has been strain hardened without further treatment and the second digit of “yy” indicates the hardness of the material on a scale from 1 to 8 with 8 being the hardest. A designation of the form “Al3xxxO” indicates an aluminum alloy in which manganese is the element other than aluminum present in the largest amount. According to this designation, the first digit after the number 3 denotes the modification status of the alloy, the second and third digits differentiate the kind of alloy, and the final “0” denotes that the alloy has been annealed.

A lithium secondary battery including the current collector of the present invention includes a positive electrode comprising a positive active material layer formed on the current collector; a negative electrode comprising a negative active material; and an electrolyte. Lithium secondary batteries may be of a large size such as those used in electric vehicles, or they may be of a small size such as those used in cellular phones or notebook computers.

For the positive active material, any compound that can reversibly intercalate or de-intercalate lithium ions can be used. One representative example is a lithiated intercalation oxide. Since such materials are well known in this field, and a description of further specific examples of the chemical composite is omitted in the present specification.

For the negative active material, any compound that can reversibly intercalate or de-intercalate lithium ions can be used, and representative examples include crystalline or amorphous carbon, carbon composites, lithium metal, or lithium alloys.

The electrolyte includes a non-aqueous organic solvent and a lithium salt.

The non-aqueous organic solvent functions as a medium which enables the movement of ions formed by the electrochemical reactions of a battery. The non-aqueous organic solvent may include a carbonate, ester, ether, or ketone. The carbonate may include dimethyl carbonate, diethyl carbonate, dipropyl carbonate, methyl propyl carbonate, ethyl propyl carbonate, methyl ethyl carbonate, ethylene carbonate, propylene carbonate, or butylene carbonate. The ester may include γ-butyrolactone, n-methyl acetate, n-ethyl acetate, or n-propyl acetate. The ether may include dibutyl ether. The ketone may include poly methylvinyl ketone.

The lithium salt enables a lithium battery to operate by functioning as a supply source of lithium ions in a battery, and the non-aqueous organic solvent functions as a medium which enables ions to move. Suitable lithium salts include those selected from the group consisting of LiPF₆, LiBF₄, LiSbF₆, LiAsF₆, LiClO₄, CF₃SO₃Li, LiN(SO₂CF₃)₂, LiC₄F₉SO₃, LiAlO₄, LiAlOCl₄, LiN(SO₂C₂F₅)₂), LiN(CₓF₂ₓ₊₁SO₂)(C_{y}F_{2y+1}SO₂) (wherein x and y are natural numbers), LiCl, Lil, and combinations thereof.

The concentration of the lithium salt in the electrolyte is preferably within the range of 0.1 to 2.0 M. When the concentration of the lithium salt in the electrolyte is less than 0.1 M, conductivity is lowered, and thus performance of the electrolyte deteriorates. When it is more than 2.0 M, the viscosity of the electrolyte is increased, leading to a decrease in the mobility of the lithium ions.

The lithium secondary battery may include a separator interposed between the positive electrode and the negative electrode. Such a separator prevents a short circuit. The separator may be provided as a membrane made of a polymer such as polyolefin, polypropylene, or polyethylene, a multi-layered membrane thereof, a micro-porous film, or any one of other widely known materials such as woven or unwoven fabrics.

The lithium secondary battery including an electrolyte, a positive electrode, a negative electrode, and a separator, as stated above, may be formed in a cell having a layered structure of a positive electrode/a separator/a negative electrode; may be formed in a bi-cell layered structure with a positive electrode/a separator/a negative electrode/a separator/a positive electrode; or may be formed as a multi-layered cell having a repeated cell structure.

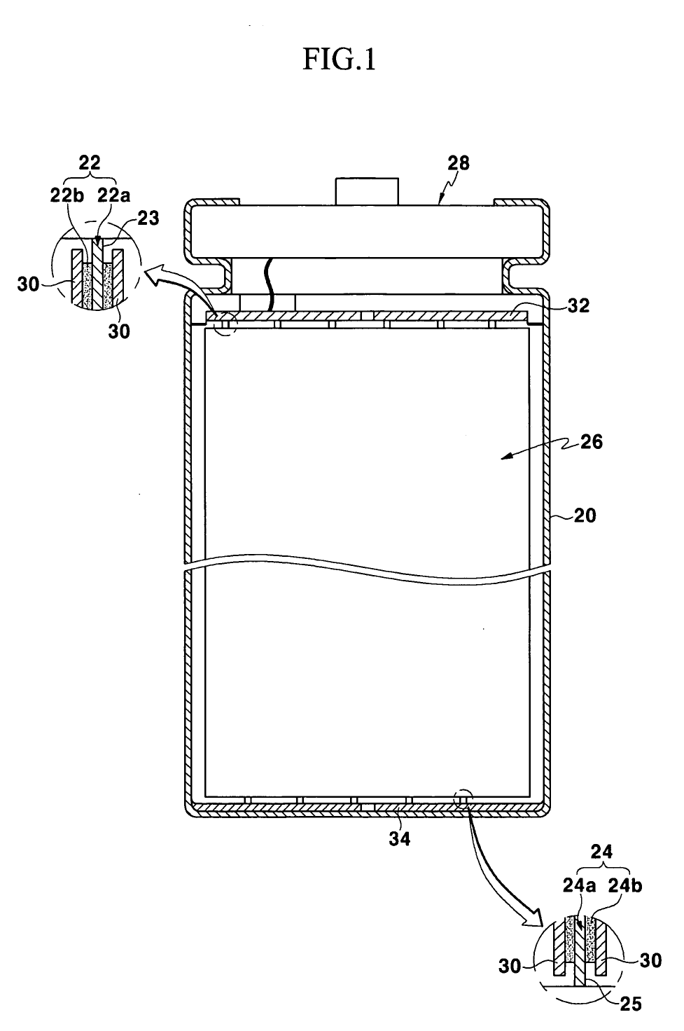

A representative example of a lithium secondary battery of the present invention is shown in FIG. 1.

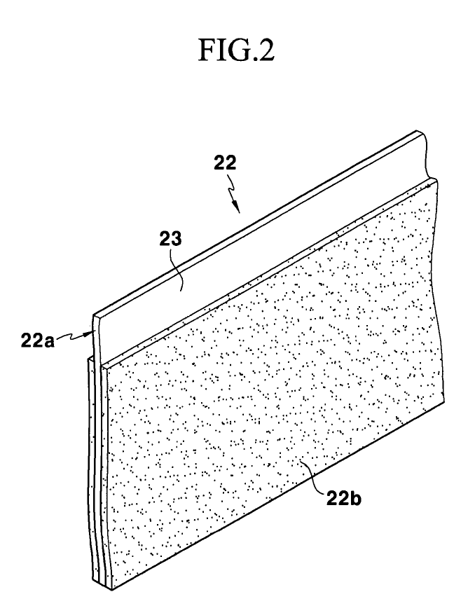

FIG. 1 shows a cylindrical type of lithium secondary battery 26 including a positive electrode 22, a negative electrode 24, and a separator 30 interposed between the positive electrode 22 and the negative electrode 24. The assembly of the positive electrode 22, the negative electrode 24 and the separator 30 is wound and inserted into a battery case 20 in which an electrolyte (not shown) is located between the positive electrode 22 and the negative electrode 24. In FIG. 1, reference numbers 32 and 34 indicate a positive and a negative lead plate respectively. Also, the positive electrode 22 and the negative electrode 24 respectively includes active material layers 22b and 24b on current collectors 22a and 24a, and uncoated portions 23 and 25, on which an active material layer is not formed on the positive electrode and the negative electrode, respectively. A partial perspective view of one of the positive electrode 22 and the negative electrode 22 or 24 is presented in FIG. 2, wherein which the positive electrode 22 includes a current collector 22a and an active material layer 22b coated on both surfaces of the current collector 22a except at a part of both ends thereof.

Of course, the present invention is not limited by this shape, and it is possible to form any type of shape such as a prismatic type, a pouch type, and so on which can serve as a battery and which includes a positive electrode active material.

The following illustrate examples and comparative examples. However, the examples described below are only examples of the present invention, and the present invention is not limited by these examples.

### EXAMPLE 1

An Al1100H16 aluminum alloy current collector with 99.00 weight percent of aluminum and 0.12 weight percent of Cu and having a tensile strength of 145 MPa was coated with a positive active material composition and dried followed by pressing. In this case, the pressing process was performed until an electrode density of 2.4g/cc was achieved and the amount of positive active material at the positive electrode was 10 mg/cm². The positive active material composition was prepared by dispersing a LiNiCoAlO₂ positive active material, a polyvinylidene fluoride binder, and a carbon conductive agent in a weight ratio of 85:10:5 in an N-methylpyrrolidone solvent.

### EXAMPLE 2

An Al31050 alloy current collector with 99.00 weight percent of aluminum and 0.55 weight percent of Mn and having a tensile strength of 115 MPa was coated with a positive active material composition, dried, and pressed. The positive active material composition was prepared by dispersing a LiNiCoAlO₂ positive active material, a polyvinylidene fluoride binder, and a carbon conductive agent in a weight ratio of 85:10:5 in an N-methylpyrrolidone solvent.

### COMPARATIVE EXAMPLE 1

A positive electrode was produced by the same method as in Example 1 except that an aluminum alloy current collector having a tensile strength of 110 MPa and an aluminum content of 99.5 weight % was used.

As described above, when a current collector is applied to a battery, a current collector of the present invention overcome the problem such that an electrode is bent during a compressing process since it has a high degree of strength and a low elongation rate. In addition, a current collector of the present invention is compatible with large sizes of batteries.

1. A current collector for a positive electrode of a lithium secondary battery, comprising:
an aluminum alloy;
wherein the current collector has a tensile strength ranging from 115 MPa to 265 MPa.

2. The current collector in accordance with claim 1, wherein the tensile strength of the current collector ranges from 115 MPa to 160 MPa.

3. The current collector in accordance with claim 1, wherein the aluminum content is from 98 to 99.5%.

4. The current collector in accordance with claim 1, wherein the aluminum alloy is selected from the group consisting of Al1050H16, Al1050H18, Al1060H18, Al1350H16, Al1350H19, Al1100H14, Al11100H16, Al1100H18, and Al31050.

5. A positive electrode comprising the current collector of claim 1 and a positive active material.

6. A battery comprising the positive electrode of claim 5, a negative electrode, and an electrolyte.

7. A current collector for a positive electrode used in a lithium secondary battery, comprising:
an aluminum alloy having an aluminum content of 98 to 99.5 weight %,
wherein the current collector has a tensile strength ranging from 115 MPa to 265 MPa.

8. The current collector in accordance with claim 7, wherein the current collector has a tensile strength from 115 MPa to 160 MPa.

9. The current collector in accordance with claim 7, wherein the aluminum alloy is selected from the group consisting of Al1050H16, Al1050H18, Al1060H18, Al1350H16, Al1350H19, Al1100H14, Al1100H16, Al1100H18, and Al31050.

10. A positive electrode comprising the current collector of claim 7 and a positive active material.

11. A battery comprising the positive electrode of claim 10, a negative electrode, and an electrolyte.

12. A lithium secondary battery comprising:
a positive electrode comprising an aluminum alloy current collector having a tensile strength from 115 MPa to 265 MPa, and a positive active material layer formed on the current collector;
a negative electrode comprising a negative active material; and
an electrolyte.

13. The lithium secondary battery in accordance with claim 12, wherein the current collector has a tensile strength from 115 MPa to 160 MPa.

14. The lithium secondary battery in accordance with claim 12, wherein the lithium secondary battery comprises an aluminum alloy having an aluminum content of 98 to 99.5 weight %.

15. The lithium secondary battery in accordance with claim 12, wherein the aluminum alloy is selected from the group consisting of Al1050H16, Al1050H18, Al1060H18, Al1350H16, Al1350H19, Al1100H14, Al1100H16, Al1100H18, and Al31050.

16. A lithium secondary battery comprising:
a positive electrode comprising an aluminum alloy current collector having an aluminum content of 98 to 99.5 weight % and having a tensile strength from 115 MPa to 265 MPa, and a positive active material layer formed on the current collector;
a negative electrode comprising a negative active material; and
an electrolyte.

17. The lithium secondary battery in accordance with claim 16, wherein the current collector has a tensile strength from 115 MPa to 160 MPa

18. The lithium secondary battery in accordance with claim 16, wherein the aluminum alloy is selected from the group consisting of Al1050H16, Al1050H18, Al1060H18, Al1350H16, Al1350H19, Al1100H14, Al1100H16, Al1100H18, and Al31050.
